(19) United States
(12) Patent Application Publication
(10) Pub. No.: US 2006/0105263 A1
(43) Pub. Date: May 18, 2006

(54) Toner composition

(75) Inventors: Karen A. Moffat, Brantford (CA); Ke Zhou, Mississauga (CA); Cuong Vong, Hamilton (CA); Richard P. N. Veregin, Mississauga (CA)

Correspondence Address: Richard M. Klein, Esq.;FAY, SHARPE, FAGAN, MINNICH & McKEE, LLP, SEVENTH FLOOR, 1100 SUPERIOR AVENUE, CLEVELAND, OH, 44114-2579, US

(73) Assignee: Xerox Corporation

(21) Appl. No.: 10/990,127

(22) Filed: Nov. 16, 2004

(51) Int. Cl. G03G 9/093

(52) U.S. Cl. 430/110.2; 430/108.21; 430/108.2; 430/109.3; 430/109.4

(57) ABSTRACT

Improved toner particles having a core-shell structure and related processes thereof are provided. The core of the toner comprises a first polymer, a complexed cationic dye pigment, and a heteropoly acid, and the shell comprises a second polymer. The heteropoly acid can effectively retain the complexed cationic dye pigment within the toner particle by complexing with one or more of the pigment cations, thereby improving the toner properties such as parent charge.

### BACKGROUND

The present disclosure is generally directed to various embodiments of toner particles having a core-shell structure and related processes thereof. More specifically, the embodiments of the present disclosure relate to toner particles and associated processes thereof, which exhibits improved stability characteristics among others.

In xerographic systems, small sized toner particles are important in achieving high image quality. Emulsion/aggregation (EA) toners are ultrafine particle toners with precisely controlled particle size, size distribution, and particle shape. Emulsion/aggregation/coalescence processes for the preparation of toners are illustrated in a number of Xerox patents, the disclosures of each of which are totally incorporated herein by reference, such as U.S. Pat. Nos. 5,290,654; 5,278,020; 5,308,734; 5,370,963; 5,344,738; 5,403,693; 5,418,108; 5,364,729; and 5,346,797. Also of interest may be U.S. Pat. Nos. 5,348,832; 5,405,728; 5,366,841; 5,496,676; 5,527,658; 5,585,215; 5,650,255; 5,650,256; 5,501,935; 5,723,253; 5,744,520; 5,763,133; 5,766,818; 5,747,215; 5,827,633; 5,853,944; 5,804,349; 5,840,462; 5,869,215; 5,869,215; 5,863,698; 5,902,710; 5,910,387; 5,916,725; 5,919,595; 5,925,488; 5,977,210; 5,994,020; 6,020,101; 6,130,021; 6,120,967 and 6,628,102. The disclosures of these patents are also totally incorporated herein by reference.

However, a difficulty sometimes associated with EA processes is that, some pigments, particularly pigments which are salts of cationic dyes, may partially or completely disassociate from the toner particle during certain step or steps of the processes. The disassociation may have certain undesirable effects on the EA toner performances and, therefore, a need exists to prevent the extent of such disassociation.

For example, the standard Imari-MF washing procedure is a common method of washing EA toners. In this procedure, the mother liquor is, for example, treated with NaOH solution to elevate the pH, followed by several washes with deionized water at room temperature, then several washes at lower pHs and slightly elevated temperatures. When, for example, styrene/n-butyl acrylate EA toner particles containing Pigment Red 81:2 (PR 81:2), a complexed phenylxanthene dye with silicomolybdic acid derivative, are subjected to a standard Imari-MF washing procedure, the fraction of soluble dye may be leached out into the aqueous phase and adhere to the surface of the EA toner particles. This is especially evident in the EA toner producing process when the aqueous slurry of toner particles containing PR 81:2 is treated with base (such as sodium hydroxide) at elevated temperatures at the start of the washing process. After treating the particle mother liquor at pH=10 and 63° C. for 1 hour, the resulting supernatant has a very intensely pink or magenta color due to the soluble cationic dye that has leached out during this step. It is believed that, when dispersed in solution, PR 81:2 is in equilibrium with a very small amount of non-complexed dye, which may result in some cationic colorant on the toner particle surface which drives the charging properties of the parent particles positive. Undesirably, this decreases the parent charge in both A- and C-zones of the toners. When this low charging Pigment Red 81:2 toner was used for charge blending studies, the stability of the blended toner was very poor and showed significant charge separation over time when blended with other colors.

As such, a new process and composition are needed to increase the negative charge of the parent particles in both A-zone and C-zone to eliminate or minimize any charge separation during toner blending evaluation. Although increasing the amount of surface additives could potentially minimize this problem, this is undesirable as it increases the materials cost of the toner and would also be likely cause poor aging as the toner additives are impacted into the toner surface.

### BRIEF DESCRIPTION

The exemplary embodiments of the present disclosure achieve one or more of the foregoing objects and provide, in one aspect, a toner particle comprising a pigment which is prepared from complexing cationic dye with a heteropoly acid to produce an insoluble pigment.

Another feature of the disclosure is to provide a toner particle having a core comprising a first polymer, a pigment composed of a cationic dye complexed with a heteropoly acid; and a shell comprising a second polymer. The heteropoly acid can effectively retain the cationic dye within the toner particle by complexing with four of the dye cations.

In still another feature of the present disclosure, a toner particle comprising a polymer, a pigment composed of a cationic dye complexed with, a heteropoly acid, and one or more toner additives selected from an offset preventing agent and silica, is provided. The heteropoly acid can stabilize any free dye within the core of the toner particle by complexing with four dye molecules.

A further feature is to provide a specific toner particle having a core-shell structure. The core of the toner particle is comprised of poly(styrene-n-butyl acrylate), silicomolybdic acid (H₄[Si(Mo₃O₁₀)₄]), polyethylene wax, colloidal silica particles, and cationic dye of the formula below: 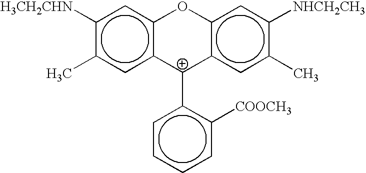
Additionally, the shell of the toner particle is comprised of poly(styrene-n-butyl acrylate). The silicomolybdic acid can stabilize the cationic dye of the formula within the toner particle by complexing with four of the dye cations.

Additionally, in another feature of the present disclosure, methods are provided for improving the parent charge properties of a toner particle containing a cationic dye, comprising introducing a heteropoly acid into the core of the toner particle to complex with and retain the complexed pigment within the toner particle.

Moreover, a further feature is to provide a method of preparing a toner particle, comprising (a) aggregating a first polymer, a pigment comprised of a cationic dye complexed with a heteropoly acid anion to construct the core of the toner particle; (b) adding a second polymer to form the shell of the toner particle; and (c) optionally isolating, washing, and drying the toner particles.

Also, in another feature of the present disclosure, methods are provided for preparing a toner particle, comprising (i) providing a heteropoly acid aqueous solution, optionally at an elevated temperature; (ii) dispersing a complexed pigment, a first polymer, and optionally an offset preventing agent into an aqueous phase containing the solution from step (i); (iii) providing an acidic mixture comprising a coagulant and a silica; (iv) initiating the toner core formation by admixing the mixtures from steps (ii) and (iii) at effectively high shearing; (v) heating the resulting sheared blend of (iv) below about the glass transition temperature (T_{g}) of the first polymer; (vi) adding a second polymer to form a shell around the core; (vii) adjusting the pH of the system with a base from pH of 2.0˜2.5 to pH of 6.5˜7.0 to prevent, or minimize additional particle growth; (viii) heating the resulting aggregate suspension to a temperature above the T_{g} of the first and second polymers; (iv) optionally treating the toner particles with acidic solutions; (v) optionally isolating, washing, and drying the toner particle.

These and other features will be more particularly described with regard to the drawings and detailed description set forth below.

### DETAILED DESCRIPTION

The present disclosure is generally directed to toner particles having core-shell structure and related processes thereof for their formation. More specifically, the disclosure relates to a toner particle and process thereof, in which the toner particle is comprised of a core comprising a first polymer, a pigment comprised of a cationic dye complexed with a heteropoly acid; and a shell comprising a second polymer. The heteropoly acid can effectively retain all of the pigment including any free dye within the core of the toner particle by complexing with one or more of the dye cations.

Generally speaking, the process of preparing the toner particle of the present disclosure comprises (a) aggregating a first polymer, a pigment previously prepared by reaction a cationic dye with a heteropoly acid anion to construct the core of the toner particle; (b) adding a second polymer to form the shell of the toner particle; and (c) isolating, washing, and drying the toner particles. For example, the disassociation of cationic soluble dye from toner particles can be prevented by adding dissolved silicomolybdic acid at 5 weight percent or higher, based upon the pigment weight, at the beginning of the aggregation process.

In an exemplary embodiment, the toner process comprises the following steps:
(i) providing a pigment previously prepared by reaction a cationic dye with heteropoly acid aqueous solution, optionally at elevated temperature;
(ii) dispersing such pigment, a first polymer, and optionally an offset preventing agent into an aqueous phase containing the solution from step (i), preferably with stirring;
(iii) providing an acidic mixture comprising a coagulant and a silica;
(iv) initiating the toner core formation by admixing the mixtures from steps (ii) and (iii) at effectively high shearing;
(v) heating the resulting sheared blend of (iv) below about the glass transition temperature (T_{g}) of the first polymer;
(vi) adding a second polymer to form a shell around the core;
(vii) adjusting the pH of the system with a base from a pH of about 2.0 to about 2.5, to a pH of about 6.5 to about 7.0 to prevent, or minimize additional particle growth;
(viii) heating the resulting aggregate suspension to a temperature above the T_{g} of the first and second polymers;
(iv) optionally treating the toner particles with acidic solutions;
(v) optionally isolating, washing, and drying the toner particle.

The heteropoly acid used in the exemplary embodiments of the present disclosure can broadly be any heteropoly acid that is effective in complexing with and thereby retaining otherwise free cationic dye in an EA toner process. When a specific pigment product originally contains a heteropoly acid, the additional heteropoly acid used to complex cationic dye according to the present disclosure may be the same as the heteropoly acid originally contained in the pigment product. Exemplary heteropoly acids include, but are not limited to, silicotungstic acid, phosphomolybdic acid, silicovanadic acid, phosphoniobic acid, tantalivanadic acid, antimoniniobic acid, phosphotungstic acid, molybdoniobic acid, niobochromic acid, phosphochromic acid, silicomolybdic acid, niobotungstic acid, phosphotungstomolybdic acid, silicochromic acid, antimonimolybdic acid, siliconiobic acid, antimonitantalic acid, silicotantalic acid, antimonitungstic acid, phosphovanadic acid, tantalitungstic acid, antimonichromic acid, molybdotungstic acid, tungstochromic acid, molybdovanadic acid, antimonivanadic acid, molybdochromic acid, tantalichromic acid, niobovanadic acid, tantaliniobic acid, phosphotantalic acid, tungstovanadic acid, vandochromic acid, molybdotantalic acid, H₄[Si(Mo₃O₁₀)₄] or H₄H₄[Si(Mo₂O₇)₆], H₃[P(W₃O₁₀)₄] or H₃H₄[P(W₂O₇)₆], H₃[P(Mo₃O₁₀)₃(W₃O₁₀)], H₃[P(Mo₃O₁₀)₄] or H₃H₄[P(Mo₂O₇)₆], and the like, and mixtures thereof. Generally, the heteropoly acid is a silicon-containing or molybdenum-containing heteropoly acid, such as silicotungstic acid, phosphomolybdic acid, silicovanadic acid, molybdoniobic acid, silicomolybdic acid, silicochromic acid, antimonimolybdic acid, siliconiobic acid, silicotantalic acid, molybdotungstic acid, phosphotungstomolybdic acid, molybdovanadic acid, molybdochromic acid, molybdotantalic acid, H₃[P(Mo₃O₁₀)₃(W₃₁₀)], H₄[Si(Mo₃O₁₀)₄] or H₄H₄[Si(Mo₂O₇)₆], H₃[P(Mo₃O₁₀)₄] or H₃H₄[P(Mo₂O₇)₆], and the like, and mixtures thereof. Typically, the heteropoly acid is a silicomolybdic acid, which can be represented by the formula H₄[Si(Mo₃O₁₀)₄], or, as some other nomenclature systems suggest, (SiO₂)·(MoO₃)₁₂·(H₂O)₂. As a skilled artisan can understand, however, the stoichiometric aspect in the formula of a heteropoly acid is idealized. The ratios between the different components can vary widely and are in actual fact controlled by, for example, pH value, and temperature etc.

In preparing the heteropoly acid aqueous solution, the heteropoly acid can be dissolved into sufficient amount of appropriate solvent, such as deionized water. Depending on the specific heteropoly acid selected and the specific solvent used to dissolve the heteropoly acid, the dissolving process can optionally be facilitated by elevating temperature, manual or magnetic stirring, or with ultrasound. For example, 0.6 grams of silicomolybdic acid can be completely dissolved into about 455 grams of deionized water by heating the solution up to 95° C. After the solution is cooled down to a lower temperature, e.g., room temperature, the solution is ready to be used in an EA toner process. Depending upon the valence, the complexing equilibrium constant(s) with coexistent cationic dye(s), the molecular weight, and other physical/chemical properties of the heteropoly acid, the effective amount of the heteropoly acid used in the present disclosure can be from about 0.5 to about 25 wt %, generally from about 2.5 to about 10 wt %, typically from about 3 to about 7 wt %, relative to the amount of the free cationic dye in the toner particles. In one specific embodiment, 0.6 grams of silicomolybdic acid from Aldrich are used together with 62.9 grams of Magenta Pigment PR81:2 dispersion (EE-20626) having 20.8% solids content, and the amount of the heteropoly acid is about 5 wt %, relative to the amount of the pigment.

According to the present disclosure, into the prepared heteropoly acid solution, e.g., silicomolybdic acid aqueous solution, which is optionally further diluted with water, can be dispersed with a cationic pigment complex, a first polymer, and optionally an offset preventing agent under appropriate conditions such as high shear stirring by means of a polytron.

The cationic pigments used herein are those pigments which comprise one or more cationic groups or cationic moieties in their molecular structures, and which, when complexed with appropriate heteropoly acid(s), can effectively be retained inside the toner particles. The retention can be achieved through, for example, changing of solubility of the complexed cationic pigment in its media such as aqueous phase. For example, when phenylxanthene dye cation complexed with silicomolybdic acid anion, the acid/base equilibrium is pushed to the complexed insoluble pigment form and thus minimizes the free cationic dye formation in toner process. In a cationic pigment molecule, the cationic group or cationic moiety can optionally be part of the chromophore of the pigment, in which the electronic transition responsible for a given spectral band is approximately localized. The positive charge of the cationic pigment can be either localized or delocalized. Commonly used cationic pigments are, for example, those containing diphenylmethane, triphenylmethane, xanthene, fluorene, methine, acridine, oxazine, phenazine, flavylium, naphthoperinone, quinophthalone, and quaternary ammonium group, etc. However, the present disclosure also includes those pigments that are broadly defined as cationic derivatives of various parent pigments, which are typically neutral, and which, on a limited basis, can also be already cationic or anionic (inner salts).

Exemplary parent pigments that can be chemically modified to cationic pigments include, but are not limited to, polycyclic pigments such as thioindigo pigments, quinacridone pigments, diketopyrrolo-pyrrole (DPP) pigments, Vat dyes pigments, perylene and perinone pigments, phthalocyanine pigments, aminoanthraquinone pigments, hydroxyanthraquinone pigments, heterocyclic anthraquinone pigments, and polycarbocyclic anthraquinone pigments (e.g. pyranthrone, anthanthrone, and isoviolanthrone etc.); azo pigments such as Monoazo Yellow and Orange pigments, disazo pigments, β-Naphthol pigments, Naphtol AS pigments (Naphthol Reds), Red Azo Pigment Lakes (salt type), benzimidazolone pigments, disazo condensation pigments, metal complex pigments, isoindolinone and isoindoline pigments; anthraquinone pigments such as anthrapyrimidine pigments, flavanthrone pigments, pyranthrone pigments, and anthanthrone pigments; dioxazine pigments include triarylcarbonium and quinophthalone pigments; and the like, and mixtures thereof.

Specific examples of parent pigments/cationic pigments that are commercially available include, but are not limited to, phthalocyanine HELIOGEN BLUE L6900™, D6840™, D7080™, D7020™, PYLAM OIL BLUE™, PYLAM OIL YELLOW™, PIGMENT BLUE 1™, available from Paul Uhlich & Company, Inc., PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Ontario, NOVAPERM YELLOW FGL™, HOSTAPERM PINK E™ from Hoechst, CINQUASIA MAGENTATA™ available from E.I. DuPont de Nemours & Company, Pigment Yellow 180, Pigment Yellow 12, Pigment Yellow 13, Pigment Yellow 14, Pigment Yellow 17, Pigment Blue 15, Pigment Blue 15:3, Pigment Red 122, Pigment Red 57:1, Pigment Red 81:1, Pigment Red 81:2, Pigment Red 81:3, and the like.

By “cationic derivatives”, it means that a parent pigment is so chemically modified that it contains one or more of (1) complexed metal ions such as Fe³⁺, Fe²⁺, Zn²⁺, Al³⁺, Ga³⁺, Ni²⁺, Cu²⁺, and Mg²⁺ etc., for example, aluminum 1,8,15,22-tetrakis(phenylthio)-29H,31H-phthalocyanine chloride, gallium(III)-phthalocyanine chloride, and iron(III) phthalocyanine chloride; (2) onium cations as showed below:

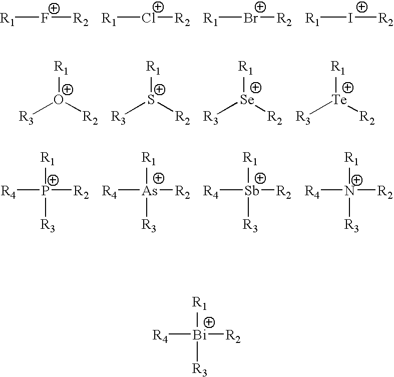

In which each of Rₙ (n=1, 2, 3, or 4) is independently any suitable univalent groups such as hydrocarbyl, for example, 3,6-diamino-10-methylacridinium (acriflavin); (3) cations formed by substitution of suitable onium ions in (2) with groups having two or three free valencies on the same atom such as hydrocarbylidyne oxonium ions, iminium ions, and nitrilium ions etc., for example, N,N,N′-trimethylthionin or methyleneazure, a cationic pigment with formula (I) as showed below: 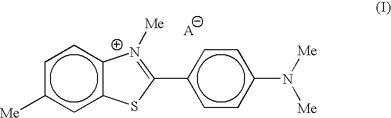
in which A^{⊖} is an anion; or (4) ylium ions or carbocations such as carbenium, carbonium, vinyl cations, and allyl cation etc.

Exemplary cationic pigments are di- or tri-arylcarbonium pigments, e.g., a cationic pigment comprising the structure as shown in formula (II) below: 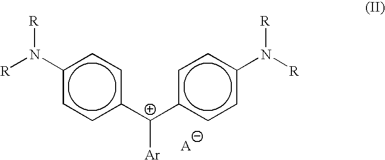
in which R is hydrogen or a lower alkyl group such as methyl, ethyl, propyl, isopropyl, and the like; Ar is an aryl group such as phenyl, 4-dimethylaminophenyl, 4-ethylaminonaphthyl, and the like.

Other exemplary cationic pigments are derivatives of 9-phenylxanthane as shown in formula (III) below: 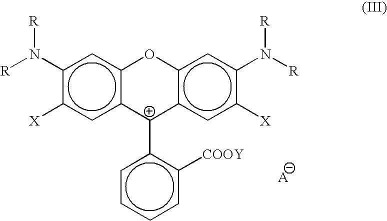
in which each of R, X, and Y is independently hydrogen or lower alkyl group such as methyl, ethyl, propyl, isopropyl, and the like. When X is methyl, Y is methyl, R is hydrogen and ethyl, a cationic pigment with the formula (IV) is given.

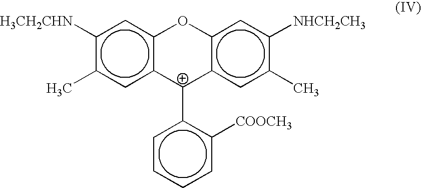

Based on the total weight of the final toner particle, the amount of the pigment present in the toner particles in accordance with the present discovery is from about 2 to about 20 wt %, generally from about 2 to about 15 wt %, and typically from about 3 to about 12 wt %.

The first polymer used to form the toner particle core of the present discovery can generally be any suitable polymer or polymer mixtures that are effective in aggregating with other components of the toner in EA process to form the core with desirable size and shape. Polyester as well as styrene acrylate in the form of a latex dispersion are preferred classes in selecting the first polymer. Examples of the first polymers selected for the present discovery include, but are not limited to, poly(styrene-n-butyl acrylate), poly(styrene-butadiene), poly(methyl methacrylate-butadiene), poly(ethyl methacrylate-butadiene), poly(propyl methacrylate-butadiene), poly(butyl methacrylate-butadiene), poly(styrene-isoprene), poly(methyl methacrylate-isoprene), poly(ethyl methacrylate-isoprene), poly(propyl methacrylate-isoprene), poly(butyl methacrylate-isoprene), poly(styrene-propyl acrylate), poly(styrene-2-ethylhexyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-2-ethylhexyl acrylate-acrylic acid), poly(styrene-butyl acrylate-methacrylic acid), poly(styrene-2-ethylhexyl acrylate-methacrylic acid), poly(styrene-butyl acrylate-acrylononitrile), poly(styrene-butyl acrylate-acrylononitrile-acrylic acid), poly(methyl methacrylate-propyl acrylate), poly(methyl methacrylate-butyl acrylate), poly(methyl methacrylate-butadiene-acrylic acid), poly(methyl methacrylate-butadiene-methacrylic acid), poly(methyl methacrylate-butadiene-acrylonitrile-acrylic acid), poly(methyl methacrylate-butyl acrylate-acrylic acid), poly(methyl methacrylate-butyl acrylate-methacrylic acid), poly(methyl methacrylate-butyl acrylate-acrylononitrile), poly(styrene-butyl acrylate-acrylononitrile-acrylic acid), polyethylene-terephthalate, polypropylene-terephthalate, polybutylene-terephthalate, polypentylene-terephthalate, polyhexalene-terephthalate, polyheptadene-terephthalate, polyoctalene-terephthalate, poly(propylene-diethylene terephthalate), poly(bisphenol A-fumarate), poly(bisphenol A-terephthalate), copoly(bisphenol A-terephthalate)-copoly(bisphenol A-fumarate), poly(neopentyl-terephthalate), polyethylene-sebacate, polypropylene-sebacate, polybutylene-sebacate, polyethylene-adipate, polypropylene-adipate, polybutylene-adipate, polypentylene-adipate, polyhexalene-adipate polyheptadene-adipate, polyoctalene-adipate, polyethylene-glutarate, polypropylene-glutarate, polybutylene-glutarate, polypentylene-glutarate, polyhexalene-glutarate, polyheptadene-glutarate, polyoctalene-glutarate, polyethylene-pimelate, polypropylene-pimelate, polybutylene-pimelate, polypentylene-pimelate, polyhexalene-pimelate, polyheptadene-pimelate and the like, and mixtures thereof.

Depending upon the specific process and components to be selected, the weight average molecular weight (Mw), number average molecular weight (Mn), molecular weight distribution (MWD) and glass transition temperature (T_{g}) of the first polymer should be suitable for the toner particle formation. The first polymer for the present discovery possesses a molecular weight M_{w} of from about 17,000 to about 60,000 daltons, a number average molecular weight Mₙ of from about 9,000 to about 18,000 daltons, and a MWD of about 2.1 to about 10. MWD is a ratio of the M_{w} to Mₙ of the toner particles, and is a measure of the polydispersity, or width, of the polymer chains. The first polymer also possesses a T_{g} of from 45° C. to about 65° C. More preferably the polymer in the present toner should possess weight average molecular weight (Mw) of about 22,000 to about 38,000 daltons, a number average molecular weight (Mn) of about 9,000 to about 13,000 daltons, and a MWD of about 2.2 to about 3.3 and generally a T_{g} of from about 48° C. to about 60° C. Based on the total weight of the final toner particle, generally the core of the toner particle polymers are present in an amount of from 40 to 70 wt %, generally from about 45 to about 65 wt %, and typically from about 46 to about 60 wt %. The polymer used to prepare the core of the toner particles can also be the same polymer used to prepare the shell of the toner particles.

The offset preventing agents used in the present discovery can be any suitable material that can be employed to prevent toner offsetting in electrostatic imaging processes such as waxes that exhibit an appropriate softening point upon heating. One type of such agent may be used alone or two or more types may be used in combination. Generally, the offset preventing agent used in the present discovery is selected from the class of wax compounds. Various examples of wax include, but are not limited to, Fischer-Tropsch wax (by coal gasification); vegetable waxes such as carnauba wax, Japan wax, Bayberry wax, rice wax, sugar cane wax, candelilla wax, tallow, and jojoba oil; animal wax such as beeswax, Shellac wax, Spermaceti wax, whale wax, Chinese wax, and lanolin; ester wax; saturated fatty acid amides wax such as capronamide, caprylamide, pelargonic amide, capric amide, laurylamide, tridecanoic amide, myristylamide, stearamide, behenic amide, and ethylene-bisstearamide; unsaturated fatty acid amides wax such as caproleic amide, myristoleic amide, oleamide, elaidic amide, linoleic amide, erucamide, ricinoleic amide, and linolenic amide; mineral waxes such as montan wax, ozokerite, ceresin, and lignite wax; petroleum waxes such as paraffin wax and microcrystalline wax; polyolefin waxes such as low-molecular polyethylene, low-molecular polypropylene, and low-molecular polybutene; synthetic waxes such as polytetrafluoroethylene wax, Akura wax, and distearyl ketone; hydrogenated waxes such as castor wax and opal wax; and modified waxes such as montan wax derivatives, paraffin wax derivatives, and microcrystalline wax derivatives, and combinations thereof.

Examples of waxes or wax emulsions that are commercially available include those available from Allied Chemical and Petrolite Corporation, Michaelman Inc, the Daniels Products Company, and the Genesee Polymers Corporation. Wax emulsions are typically prepared as dispersions of a wax in water, which dispersion is comprised of a wax, and a dispersant such as a nonionic, ionic or a mixture of surfactants. A specific example of wax is POLYWAX 725™ wax emulsion (polyethylene wax, 30 percent active, Baker Petrolite).

Depending upon the specific process and components to be selected, the molecular weight and melting temperature of the offset preventing agents should promote formation of the toner particle. The offset preventing agent, if it is wax, for the present discovery possesses a molecular weight Mₙ of from about 400 to about 1500, and more generally from about 500 to about 1000, and a melting temperature Tₘ of from about 60° C. to about 120° C., and generally from about 65° C. to about 110° C.

The offset preventing agents in the product of the present disclosure are present in various amounts. However, based on the total weight of the final toner particle, generally the offset preventing agents are present in an amount of from about 3 to about 30 wt %, generally from about 3 to about 28 wt %, and typically from about 3 to about 25 wt %.

The mixture, typically an acidic mixture, comprising a coagulant and a silica can be prepared by any conventional methods that are known to a person skilled in the art. For example, a coagulant can be dispersed in an acidic solution, such as 0.02M HNO₃ solution. Silica can then be mixed with the coagulant acidic solution for a prolonged period of time, e.g. 20 minutes.

As an important additive to the toner particles, the silica imparts several advantageous properties to the toner, including, for example, toner flow, tribo enhancement, admix control, improved development and transfer stability and higher toner blocking temperature. The silica can be colloidal silica particles, i.e., silica particles having a volume average particle size, for example as measured by any suitable technique such as by using a Coulter Counter, of from about 5 nm to about 200 nm in an aqueous colloidal dispersion. The colloidal silica may contain, for example, about 2% to about 30% solids, and generally from about 2% to about 20% solids. In an exemplary embodiment, the colloidal silica particles have a bimodal average particle size distribution. Specifically, the colloidal silica particles comprise a first population of colloidal silica particles having a volume average particle size of from about 5 to about 200 nm, and generally from about 5 nm to about 100 nm, and a second population of colloidal silica particles having a volume average particle size of about 5 to about 200 nm, and generally about 5 to about 100 nm, although the particle size can be outside of these ranges. The first group of colloidal silica particles may comprise, e.g., SNOWTEX OS supplied by Nissan Chemical Industries (about 8 nm), while the second group of colloidal silica particles may comprise, e.g., SNOWTEX OL supplied by Nissan Chemical Industries (about 40 nm). It is believed that the smaller sized colloidal silica particles are beneficial for toner gloss, while the larger sized colloidal silica particles are beneficial for toner release properties. Therefore the toner release properties and the toner gloss may be controlled by varying the ratio of differently sized colloidal silica particles.

Other properties of silica to be added should be suitable for, or at least not detrimental to, the toner process of the present discovery. For example, the Snowtex OL colloidal silica has such properties as 20-21 wt % of SiO₂, less than 0.04% of flammable alkali (as Na₂O), 2-4 of pH value, spherical particle shape, 40-50 nm particle size, <3 mPa.s. Viscosity at 25° C., 1.12-1.14 specific gravity at 25° C., and opalescent appearance.

The total amount of silica added into the toner formulation may vary between, for example, about 0.0% to about 15% by weight, generally about 0.0% to about 10% by weight, and typically about 0% to about 10% by weight, of the total weight of the toner particle. In case the silica contains a first group of colloidal silica and a second group of colloidal silica, the first group of colloidal silica particles are present in an amount of from about 0.0% to about 15%, and generally about 0.0% to about 10%, of the total amount of silica; and the second group of colloidal silica particles are present in an amount of from about 0.0% to about 15%, and generally about 0.0% to about 10%, of the total amount of silica.

The coagulant used in the present discovery processes can be any chemical species of ionic nature that is able to aggregate the first polymer, together with the pigment, offset preventing agent and/or silica in forming the core of the toner particle. Generally, the coagulants can be a poly(metal halide) such as poly(aluminium chloride) (PAC); poly(metal sulfosilicate) such as poly(aluminium sulfosilicate) (PASS); salts of bivalent and trivalent metals such as iron(II) sulfate, zinc chloride, magnesium chloride, iron(III) sulfate, zinc sulfate, aluminum sulfate, iron(II) chloride, iron(III) chloride, magnesium sulfate, and the like; and mixtures thereof. Suitable organic coagulants are also contemplated within the scope of the present discovery. The coagulant is preferably in solution having an amount of from, for example, 0.10 to 0.30 parts per hundred (pph) and generally in the range of from about 0.12 to about 0.20 parts per hundred (pph) of the total amount of the solution. The coagulant may also contain minor amounts of other components, for example nitric acid.

Based on the total weight of the final toner particle, generally the coagulants are present in an amount of from about 0.10 to about 0.30 pph, preferably from about 0.12 to about 0.20 pph, and typically from about 0.12 to about 0.20 pph.

The formation of the core of the toner particle disclosed herein is initiated by admixing the system, e.g. dispersion comprising the pigment consisting of the heteropoly acid, with cationic dye, the first polymer, and optionally the offset preventing agent, with the mixture of silica and coagulant as prepared above, and further with, if desired, an amount of coagulant solution such as acidic solution. If an increase of viscosity is observed in the aggregating system, it may be desirable to reinforce the stirring condition for a period of time in order to form well-defined toner particles. Typically, the procedure is believed to result in, for example, a flocculation or hetero-coagulation of gelled particles comprising nanometer sized polymer particles, cationic dye pigments, silica, and optionally offset preventing agent for the core of the toner particles.

The resulting sheared blend of the first polymer particles, the cationic pigments, the silica, and optionally the offset preventing agent can be heated, preferably in a gradual manner, to an appropriate temperature that is generally below about the glass transition temperature (T_{g}) of the first polymer, and maintained at the temperature at a sufficiently prolonged period of time. The procedure typically produces toner core particles of a size of from about 3 to about 20 microns, generally from about 3 to about 15 microns. In a preferred embodiment, the toner particles have a very narrow particle size distribution with a lower number ratio geometric standard deviation (GSD) of approximately 1.15 to approximately 1.30, more preferably approximately less than 1.25. The toner particles of the invention also preferably have a size such that the upper geometric standard deviation (GSD) by volume is in the range of from about 1.15 to about 1.30, preferably from about 1.18 to about 1.24, more preferably less than 1.25. These GSD values for the toner particles of the invention indicate that the toner particles are made to have a very narrow particle size distribution. In a specific embodiment of the present disclosure, PR81:2/SDC-EP8/Snowtex-OL/Sonwtex-OS/Polywax725 slurry can be heated at a controlled rate of 0.5° C./minute up to approximately 47° C. and held at this temperature for 75 minutes producing particles of approximately 5.0 microns and a GSD of 1.21 as measured by a Coulter Counter.

Once the core particles with desired size and shape are formed, a second polymer, preferably in latex form, can then be introduced into the toner process to construct a shell around the core under proper conditions such as stirring. The second polymer used to form the shell can generally be any suitable polymers or polymer mixtures that are effective in aggregating around the core and building up the shell with desirable size and shape. The second polymer can be same as or different from the first polymer used to form the core of the toner particles. Preferably the second polymer is a polyester as well as styrene acrylate in the form of a latex dispersion. For illustrative purposes, examples of the second polymers selected for the present disclosure include, but are not limited to, poly(styrene-n-butyl acrylate), poly(styrene-butadiene), poly(methyl methacrylate-butadiene), poly(ethyl methacrylate-butadiene), poly(propyl methacrylate-butadiene), poly(butyl methacrylate-butadiene), poly(styrene-isoprene), poly(methyl methacrylate-isoprene), poly(ethyl methacrylate-isoprene), poly(propyl methacrylate-isoprene), poly(butyl methacrylate-isoprene), poly(styrene-propyl acrylate), poly(styrene-2-ethylhexyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-2-ethylhexyl acrylate-acrylic acid), poly(styrene-butyl acrylate-methacrylic acid), poly(styrene-2-ethylhexyl acrylate-methacrylic acid), poly(styrene-butyl acrylate-acrylononitrile), poly(styrene-butyl acrylate-acrylononitrile-acrylic acid), poly(methyl methacrylate-propyl acrylate), poly(methyl methacrylate-butyl acrylate), poly(methyl methacrylate-butadiene-acrylic acid), poly(methyl methacrylate-butadiene-methacrylic acid), poly(methyl methacrylate-butadiene-acrylonitrile-acrylic acid), poly(methyl methacrylate-butyl acrylate-acrylic acid), poly(methyl methacrylate-butyl acrylate-methacrylic acid), poly(methyl methacrylate-butyl acrylate-acrylononitrile), poly(styrene-butyl acrylate-acrylononitrile-acrylic acid), polyethylene-terephthalate, polypropylene-terephthalate, polybutylene-terephthalate, polypentylene-terephthalate, polyhexalene-terephthalate, polyheptadene-terephthalate, polyoctalene-terephthalate, poly(propylene-diethylene terephthalate), poly(bisphenol A-fumarate), poly(bisphenol A-terephthalate), copoly(bisphenol A-terephthalate)-copoly(bisphenol A-fumarate), poly(neopentyl-terephthalate), polyethylene-sebacate, polypropylene-sebacate, polybutylene-sebacate, polyethylene-adipate, polypropylene-adipate, polybutylene-adipate, polypentylene-adipate, polyhexalene-adipate polyheptadene-adipate, polyoctalene-adipate, polyethylene-glutarate, polypropylene-glutarate, polybutylene-glutarate, polypentylene-glutarate, polyhexalene-glutarate, polyheptadene-glutarate, polyoctalene-glutarate, polyethylene-pimelate, polypropylene-pimelate, polybutylene-pimelate, polypentylene-pimelate, polyhexalene-pimelate, polyheptadene-pimelate and the like, and mixtures thereof.

The molecular weight and glass transition temperature (T_{g}) of the second polymer should be suitable for the shell construction. The second polymer preferably exhibits a weight average molecular weight M_{w} of from about 17,000 to about 60,000 daltons, and generally from about 22,000 to 38,000 daltons; number average molecular weight (Mn), of from about 9,000 to about 18,000 daltons and generally from about 9,000 to about 13,000 daltons; a molecular weight distribution (MWD) of from about 2.1 to about 10, and generally from about 2.2 to about 3.3 and a T_{g} of from about 45° C. to about 65° C., and generally from about 48° C. to about 60° C. Based on the total weight of the final toner particle, the second polymers are present in an amount of from about 10 to about 50 wt %, generally from about 12 to about 40 wt %, and typically from about 15 to about 35 wt %.

The particle growth can be effectively halted or slowed by adjusting the pH of the system with a base, so that the pH of the system is changed from about 2.0 to about 7.0, to a pH of from about 2.5 to about 6.5. In a specific embodiment of the present invention, the pH of the toner system was adjusted from 2.0 to 6.5 with aqueous base solution of 4 percent sodium hydroxide, followed by an additional 15 minutes of stirring to freeze the particle size.

Coalescing of the core-shell toner particle can be carried out under appropriate conditions such as temperature, pH, and coalescing time etc. Preferably, the coalescing temperature is reasonably higher than the T_{g} of both the second and first polymers; the coalescing pH is about from 5.5 to 7.0; and the coalescing time is from about 2.5 to about 6 hours. When heating is needed to achieve the coalescing temperature, it is generally performed in a gradual manner. For example, coalescing of PR81:2/SDC-EP8/Snowtex-OL/Sonwtex-OS/Polywax725/SDC-EP8 system is fulfilled at 96° C., pH 6.3, and in 5 hours. After cooling of the toner system, the particle size is from about 5.0 to about 6.5 microns, generally from about 5.3 to about 6.0 microns, and with a GSD by volume is in the range of from about 1.15 to about 1.30, preferably from about 1.18 to about 1.27, more preferably less than 1.25. and a GSD by number is in the range of from about 1.18 to about 1.40, preferably from about 1.20 to about 1.30 and more preferably less than 1.30.

According to the present disclosure, a sufficient amount of appropriate solvent such as water can be used to wash the core-shell toner particles for one or more times, optionally before or after the toner particles are treated with acidic solution with a pH value of about 2.0 to 4.0, at a temperature of about 24 to 45° C., and for a period of from 20 minutes to 2 hours.

The preparation of the core-shell toner particles may be concluded by effectively drying the product, such as, by lyophilization for a period of from about 1 to about 4 days. The final product has a particle size of about 5.0 to 6.5 microns, generally from about 5.3 to about 6.0 microns, and with a GSD by volume of less than 1.28 and a GSD by number of less than 1.30.

Utilizing this process, many custom colored toners can be prepared using SDC-EP8 latex, 2% Snowtex OL colloidal silica, 3% Snowtex OS colloidal silica, 9% POLYWAX®725, 0.14 pph PAC and different loadings of appropriate pigments dispersed into a Neogen RK aqueous surfactant system.

Without being limited to any particular theory, it is believed that the addition of heteropoly acid pushes the cationic dye pigment equilibrium to the desired, complexed pigment form and thus minimizes or eliminates the free cationic (alkaline soluble) dye formation. As a specific example will illustrate, Pigment Red 81:2, which is a salt of cationic dye and specifically a phenylxanthene derivative cation, reacts with complex inorganic acids such as silicomolybdic acid, producing a sufficiently less soluble pigment from an alkaline and polar medium. Under acidic conditions the pigment complex is more stable than the dye form. It is also believed that, stoichiometrically, up to four Pigment Red 81:2 cationic units are coordinated with one silicomolybdic acid. The disclosure is particularly advantageous in EA toner process, for example, Imari-MF washing procedure. Standard Imari-MF washing procedure comprises 6 washing treatments of toner particles, where the 1st wash is conducted at pH of 10 at 63° C., followed by 3 washes with deionized water at room temperature, one wash carried out at a pH of 4.0 at 40° C., and finally the last wash with deionized water at room temperature.

Specific embodiments of the disclosure will now be described in detail. These examples are intended to be illustrative, and the disclosure is not limited to the materials, conditions, or process parameters set forth in these embodiments. All parts and percentages are by weight unless otherwise indicated.

### COMPARATIVE EXAMPLE 1

### Preparation of Pigment Red 81:2 Magenta Styrene/n-Butyl Acrylate EA Toner Particles Without Using Silicomolybdic Acid

This example containing Pigment Red 81:2 at 6% by weight of toner is the control, which is washed by the standard Imari washing procedure.

Into a 2 liter glass reactor equipped with an overhead stirrer and heating mantle was dispersed 256.1 grams of Latex A having a 41.40% solids content, 59.98 grams of POLYWAX® 725 dispersion having a solids content of 30.76%, 65.4 grams of a Magenta Pigment PR81:2 dispersion (EE-20626) having a solids content of 20.0% and 602.4 grams of water. High shear stirring was performed by a polytron. Separately prepared were 28 grams of a coagulant solution consisting of 10 weight percent poly(aluminiumchloride), PAC and 90 wt. % 0.02M HNO₃ solution. In a separate beaker was added 19.05 grams of Snowtex OL colloidal silica, 28.57 grams of Snowtex OS colloidal silica and 9.33 grams of the acidic PAC solution. This solution was mixed for 20 minutes prior to addition to the pigmented latex wax solution during the high shear stirring step. After all the colloidal silica was added, the remaining PAC solution was added dropwise at low rpm. As the viscosity of the pigmented latex silica mixture increased, the rpm of the polytron probe also increased to 5,000 rpm for a period of 2 minutes. This produced a flocculation or heterocoagulation of gelled particles consisting of nanometer sized latex particles, 9% wax, 2% OL silica, 3% OS silica and 6% pigment for the core of the particles. The pigmented latex/wax/silica slurry was heated at a controlled rate of 0.5° C./minute up to approximately 47° C. and held at this temperature for 75 minutes producing particles of approximately 5.0 microns and a GSDv=1.21. Once the average particle size of 5.0 microns was achieved, 137.9 grams of the latex SDC-EP8 was then introduced into the reactor while stirring to produce a shell around the pigmented wax core. After an additional 30 minutes, the particle size measured was 5.83 microns with a GSDv=1.21. The pH of the resulting mixture was then adjusted from 2.0 to 6.5 with aqueous base solution of 4 percent sodium hydroxide and allowed to stir for an additional 15 minutes to prevent any further change in the particle size. Subsequently, the resulting mixture was heated to 96° C. at 1.0° C. per minute and the particle size measured was 6.15 microns with a GSD of 1.21. The pH was then reduced to 6.3 using a 2.5 percent Nitric acid solution. The resultant mixture was then allowed to coalesce for 5 hours at a temperature of 96° C. The morphology of the particles was smooth and “potato” shape. The final particle size after cooling but before washing was 6.15 microns with a GSD by volume of 1.20. A second 200 grams batch identical to the procedure stated above was also prepared. After complete particle coalescence and base treatment of the mother liquor, the two batches were combined together and the toner was washed as one sample as follows. The particles were washed 5 times, where the mother liquor was treated with NaOH solution to raise the pH to 10 at 63° C. for 1 hour then removed, followed by 3 washes with deionized water at room temperature, one wash carried out at a pH of 4.0 at 40° C., and finally the last wash with deionized water at room temperature. The final average particle size of the dried particles was 6.34 microns with a GSDv=1.21 and a GSDn=1.24. The two batches (200 gram scale) were combined together during washing to give an overall yield of 350.2 grams (87.6 percent) yield. The glass transition temperature of this toner was 47.7° C. as measured by Differential Scanning Calorimetry (DSC) thermograms.

### EXAMPLE 1

### Preparation of Pigment Red 81:2 Magenta Styrene/n-Butyl Acrylate EA Toner Particles Using Silicomolybdic Acid

In this aspect of the present disclosure, water soluble silicomolybdic acid was added at the beginning of the styrene/butyl acrylate EA toner producing process. This resulted in driving the pigment equilibrium further to the complexed form, and thus minimizing or eliminating the free alkaline soluble pigment. The example utilized 6% pigment with silicomolybdic acid added in the EA process followed by dividing the toner into three portions (Portion A, Portion B, and Portion C) and washing separately with different protocols.

Into a 600 milliliter beaker was added 0.6 grams of silicomolybdic acid (Aldrich) (5 weight percent of by weight of pigment) to 454.9 grams of deionized water. The solution was heated to 95° C. to completely dissolve the acid. The silicomolybdic acid added at 5 weight percent or higher by weight of pigment could also be completely dissolved in boiling water. After cooling this aqueous solution was used to prepared EA toner sample in the following process. Into a 2 liter glass reactor equipped with an overhead stirrer and heating mantle was dispersed 256.1 grams of latex SDC-EP8 having a 41.40% solids content, 59.98 grams of POLYWAX®725 (Baker-Petrolite) dispersion having a solids content of 30.76%, 62.9 grams of a Magenta Pigment PR81:2 dispersion (EE-20626) having a solids content of 20.8% into 604.9 grams of water (454.9 grams of silicomolybdic acid solution plus 150 grams of deionized water) with high shear stirring by use of a polytron. Separately was prepared 28 grams of a coagulant solution consisting of 10 wt. % poly(aluminiumchloride), PAC and 90 wt. % 0.02M HNO₃ solution. In a separate beaker was added 19.05 grams of Snowtex OL colloidal silica, 28.57 grams of Snowtex OS colloidal silica and 9.33 grams of the acidic PAC solution. This solution was mixed with for 20 minutes prior to addition to the pigmented latex wax solution during the high shear stirring step. After all of the colloidal silica was added the remaining PAC solution was added dropwise at low rpm and as the viscosity of the pigmented latex silica mixture increased, the rpm of the polytron probe also increased to 5,000 rpm for a period of 2 minutes. This produced a flocculation or heterocoagulation of gelled particles consisting of nanometer sized latex particles, 9% wax, 2% OL silica, 3% OS silica and 6% pigment for the core of the particles. The pigmented latex/wax/silica slurry was heated at a controlled rate of 0.5° C./minute up to approximately 47° C. and held at this temperature for 75 minutes producing particles of approximately 5.0 microns and a GSDv=1.21. Once the average particle size of 4.83 microns was achieved, 137.9 grams of the latex SDC-EP8 was then introduced into the reactor while stirring to produce a shell around the pigmented wax core. After an additional 30 minutes the particle size measured was 5.60 microns with a GSDv=1.19. The pH of the resulting mixture was then adjusted from 2.0 to 6.5 with aqueous base solution of 4% sodium hydroxide and allowed to stir for an additional 15 minutes to freeze the particle size. Subsequently, the resulting mixture was heated to 96° C. at 1.0° C. per minute and the particle size measured was 5.71 microns with a GSD of 1.20. The pH was then reduced to 6.3 using a 2.5% Nitric acid solution. The resultant mixture was then allowed to coalesce for 5 hours at a temperature of 96° C. The morphology of the particles was smooth and “potato” shape. The final particle size after cooling but before washing was 5.71 microns with a GSD by volume of 1.21. This sample was divided into three portions, labeled respectively as Portion A, Portion B, and Portion C, and each portion was washed differently. In all cases base treatment of the mother liquor was not performed. The parent charge of the dried toner particles was measured in both A-zone and C-zone.

### EXAMPLE 1-A

The sample was the Portion A from Example 1. Portion A did not have base treatment of the mother liquor and did not have acid treatment either. Portion A was washed three times with deionized water (room temperature, 40 minutes) after removal of the mother liquor, and then freeze dried for 2 days. The final average particle size of the dried particles was 5.65 microns with a GSDv=1.19 and a GSDn=1.21.

### EXAMPLE 1-B

The sample was the Portion B from Example 1. Portion B did not have base treatment of the mother liquor. Portion B was washed three times with deionized water (room temperature, 40 minutes) after removal of the mother liquor, then treated with 1 N HNO₃ to pH=2 at 40° C. for 40 minutes, and then finally washed with deionized water at a room temperature for 40 minutes. The resulting particles were freeze dried for 2 days. The final average particle size of the dried particles was 5.65 microns with a GSDv=1.19 and a GSDn=1.21.

### EXAMPLE 1-C

The sample was the Portion C from Example 1. Portion B did not have base treatment of the mother liquor. Portion B was washed three times with deionized water (room temperature, 40 minutes) after removal of the mother liquor, then treated with 1N HNO₃ to pH=4 at 40° C. for 40 minutes, and then followed by a final washed with deionized water at a room temperature for 40 minutes. The resulting particles were freeze dried for 2 days. The final average particle size of the dried particles was 5.65 microns with a GSDv=1.19 and a GSDn=1.21.

### EXAMPLE 2

### Testing of Toner Particles

For the evaluation of toner particles from Comparative Example 1, the parent charge was measured by conditioning the toner at 5% TC (Toner Carrier) with standard 35 micron Xerox DocuColor 2240 carrier, in both A-zone and C-zone overnight, followed by charge evaluation after either 2 minutes or 60 minutes of mixing on a Turbula mixer. For the evaluations of toner particles from Example 1-A, Example 1-B, and Example 1-C, the parent charge was measured as described above. The results are presented in Table 1.

It is expected that the fusing performance of Comparative Example 1 toner will be similar to EA1 toner in the Free-Belt Nip Fuser. It is expected that the fusing performance of toners from Example 1-A, Example 1-B, and Example 1-C will be similar to EA1 toner in the Free-Belt Nip Fuser.

Humidity sensitivity is an important charging property for EA toners. The charging performance was tested in two environmental chambers, one is a low-humidity zone (also known as the C-zone), while another one is a high humidity zone (also known as the A-zone). The C-zone had a 15% relative humidity (RH) at an operating temperature of 10° C., and the A-zone had a 85% relative humidity at an operating temperature of 28° C. The quantity of charge is a value measured through image analysis of the charge-spectrograph process (CSG). Toner charge-to-diameter ratios (q/d) in C- and A-zones, typically with a unit of femtocoulombs/micron (mm), were measured on a known standard charge spectrograph. Toner sensitivity to relative humidity or RH sensitivity is defined as the ratio of C-zone q/d to A-zone q/d. The following parent charges were measured, set forth below in Table 1.

TABLE 1
Parent charges

| q/d (mm) | |
|---|---|
| A-zone | C-zone |

| Toner | 2 min. | 60 min. | 2 min. | 60 min. |
|---|---|---|---|---|
| Comparative Ex. 1 | 0.6 | 5.6 | −1.8 | 0.4 |
| Example 1-A | −1.0 | 2.0 | −13.0 | −8.1 |
| Example 1-B | −2.1 | 0.3 | −15.6 | −8.6 |
| Example 1-C | −1.2 | 1.4 | −15.4 | −8.6 |

In this example, the addition of silicomolybdic acid solution as 5 percent by weight of pigment or higher at the beginning of the styrene/butyl acrylate EA toner preparation process increased the complexation of cationic dye to produce more pigment in Pigment Red 81:2. After washing the toner particles by three different methods, the parent charge was significantly increased in both A-zone and C-zone. The different washing procedures suggests that it was not the washing that was increasing the parent particle charge but rather, the enhanced complexation of the silicomolybdic acid with the free dye to favor the insoluble pigment that was enhancing the negative charge of the resulting Pigment Red 81:2 EA particles.

As illustrated in Table 1, the novel process effectively enhanced the stability and the negative charge of parent styrene/butyl acrylate EA particles in A-zone after 60 minutes of blending time. Since the charging performance of the parent particles is significantly improved by this silicomolybdic acid treatment, the present disclosure effectively provides an improved Aggregation/Coalescence process that increases the parent charge in both A- and C-zone of toners colored with cationic pigment.

In practice, this example describes a new method to increase in the A-zone and C-zone parent charge of Pigment Red 81:2 S/BA particles to meet the 60 minute charging specification of −4 mm for A-zone and −20 mm for C-zone. Products that will benefit are those that provide custom color applications in future Xerox products.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A toner particle comprising: a core comprising a first polymer, a complexed cationic dye pigment, and a heteropoly acid; and a shell disposed about said core, said shell comprising a second polymer; wherein said heteropoly acid retains said free cationic dye within the core by complexing with one or more of said dye cations.

2. The toner particle of claim 1, wherein the core further comprises an offset preventing agent.

3. The toner particle of claim 1, wherein the core further comprises silica.

4. The toner particle of claim 1, wherein the heteropoly acid is selected from the group consisting of silicotungstic acid, phosphomolybdic acid, silicovanadic acid, phosphoniobic acid, tantalivanadic acid, antimoniniobic acid, phosphotungstic acid, molybdoniobic acid, niobochromic acid, phosphochromic acid, silicomolybdic acid, niobotungstic acid, phosphotungstomolybdic acid, silicochromic acid, antimonimolybdic acid, siliconiobic acid, antimonitantalic acid, silicotantalic acid, antimonitungstic acid, phosphovanadic acid, tantalitungstic acid, antimonichromic acid, molybdotungstic acid, tungstochromic acid, molybdovanadic acid, antimonivanadic acid, molybdochromic acid, tantalichromic acid, niobovanadic acid, tantaliniobic acid, phosphotantalic acid, tungstovanadic acid, vandochromic acid, molybdotantalic acid, and mixtures thereof.

5. The toner particle of claim 1, wherein the heteropoly acid is selected from the group consisting of H₄[Si(Mo₃O₁₀)₄], H₄H₄[Si(Mo₂O₇)₆], H₃[P(W₃O₁₀)₄], H₃H₄[P(W₂O₇)₆], H₃[P(Mo₃O₁₀)₃(W₃O₁₀)], H₃[P(Mo₃O₁₀)₄], H₃H₄[P(Mo₂O₇)₆], and mixtures thereof.

6. The toner particle of claim 1, wherein the heteropoly acid is a silicon-containing or molybdenum-containing heteropoly acid.

7. The toner particle of claim 1, wherein the heteropoly acid is silicomolybdic acid.

8. The toner particle of claim 1, wherein the amount of heteropoly acid is from about 0.5 to about 25 wt %, relative to the amount of the cationic pigment in the toner particle.

9. The toner particle of claim 1, wherein the amount of heteropoly acid is from about 2.5 to about 10 wt %, relative to the amount of the complexed cationic dye pigment in the toner particle.

10. The toner particle of claim 1, wherein the amount of heteropoly acid is from about 3 to about 7 wt %, relative to the amount of the complexed cationic dye pigment in the toner particle.

11. The toner particle of claim 1, wherein the complexed cationic dye pigment includes a moiety selected from the group consisting of diphenylmethane, triphenylmethane, xanthene, 9-phenylxanthene, fluorene, methine, acridine, oxazine, phenazine, flavylium, naphthoperinone, quinophthalone, quaternary ammonium group and combinations thereof.

12. The toner particle of claim 1, wherein the complexed cationic dye pigment is a derivative selected from the group consisting of polycyclic pigment, azo pigment, anthraquinone pigment, and dioxazine pigment.

13. The toner particle of claim 1, wherein the complexed cationic dye pigment is a derivative selected from the group consisting of thioindigo pigment, quinacridone pigment, diketopyrrolo-pyrrole (DPP) pigment, Vat dyes pigment, perylene and perinone pigment, phthalocyanine pigment, aminoanthraquinone pigment, hydroxyanthraquinone pigment, heterocyclic anthraquinone pigment, polycarbocyclic anthraquinone pigment, pyranthrone, anthanthrone, isoviolanthrone, Monoazo Yellow and Orange pigment, disazo pigment, β-Naphthol pigment, Naphtol AS pigment (Naphthol Reds), Red Azo Pigment Lakes (salt type), benzimidazolone pigment, disazo condensation pigment, metal complex pigment, isoindolinone and isoindoline pigment, anthrapyrimidine pigment, flavanthrone pigment, pyranthrone pigment, anthanthrone pigment, triarylcarbonium, quinophthalone pigment, and combinations thereof.

14. The toner particle of claim 1, wherein the complexed cationic dye pigment has a structure according to formula (I):

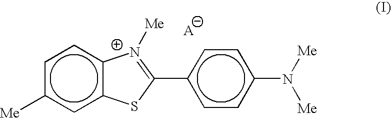

15. The toner particle of claim 1, wherein the complexed cationic dye pigment has a structure according to formula (II): 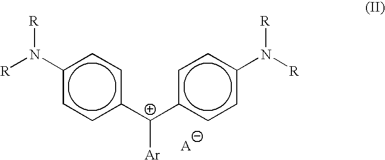
in which R is hydrogen or a lower alkyl group such as methyl, ethyl, propyl, isopropyl; Ar is an aryl group such as phenyl, 4-dimethylaminophenyl, 4-ethylaminonaphthyl.

16. The toner particle of claim 1, wherein the complexed cationic dye pigment has a structure according to formula (III): 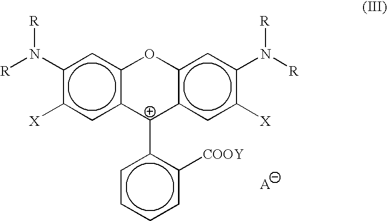
in which each of R, X, and Y is independently hydrogen or lower alkyl group such as methyl, ethyl, propyl, isopropyl.

17. The toner particle of claim 1, wherein the complexed cationic dye pigment has a structure according to formula (IV):

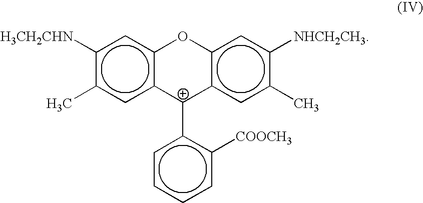

18. The toner particle of claim 1, wherein the amount of the complexed cationic dye pigment is from about 2 to about 20 wt % of the total weight of the toner particle.

19. The toner particle of claim 1, wherein the amount of the complexed cationic dye pigment is from about 2 to about 15 wt % of the total weight of the toner particle.

20. The toner particle of claim 1, wherein the amount of the complexed cationic dye pigment is from about 3 to about 12 wt % of the total weight of the toner particle.

21. The toner particle of claim 1, wherein the first polymer comprises at least one of polyester and poly (styrene acrylate).

22. The toner particle of claim 1, wherein the first polymer is in the form of a latex dispersion.

23. The toner particle of claim 1, wherein the first polymer is selected from the group consisting of poly(styrene-n-butyl acrylate), poly(styrene-butadiene), poly(methyl methacrylate-butadiene), poly(ethyl methacrylate-butadiene), poly(propyl methacrylate-butadiene), poly(butyl methacrylate-butadiene), poly(styrene-isoprene), poly(methyl methacrylate-isoprene), poly(ethyl methacrylate-isoprene), poly(propyl methacrylate-isoprene), poly(butyl methacrylate-isoprene), poly(styrene-propyl acrylate), poly(styrene-2-ethylhexyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-2-ethylhexyl acrylate-acrylic acid), poly(styrene-butyl acrylate-methacrylic acid), poly(styrene-2-ethylhexyl acrylate-methacrylic acid), poly(styrene-butyl acrylate-acrylononitrile), poly( styrene-butyl acrylate-acrylononitrile-acrylic acid), poly(methyl methacrylate-propyl acrylate), poly(methyl methacrylate-butyl acrylate), poly(methyl methacrylate-butadiene-acrylic acid), poly(methyl methacrylate-butadiene-methacrylic acid), poly(methyl methacrylate-butadiene-acrylonitrile-acrylic acid), poly(methyl methacrylate-butyl acrylate-acrylic acid), poly(methyl methacrylate-butyl acrylate-methacrylic acid), poly(methyl methacrylate-butyl acrylate-acrylononitrile), poly(styrene-butyl acrylate-acrylononitrile-acrylic acid), polyethylene-terephthalate, polypropylene-terephthalate, polybutylene-terephthalate, polypentylene-terephthalate, polyhexalene-terephthalate, polyheptadene-terephthalate, polyoctalene-terephthalate, poly(propylene-diethylene terephthalate), poly(bisphenol A-fumarate), poly(bisphenol A-terephthalate), copoly(bisphenol A-terephthalate)-copoly(bisphenol A-fumarate), poly(neopentyl-terephthalate), polyethylene-sebacate, polypropylene-sebacate, polybutylene-sebacate, polyethylene-adipate, polypropylene-adipate, polybutylene-adipate, polypentylene-adipate, polyhexalene-adipate polyheptadene-adipate, polyoctalene-adipate, polyethylene-glutarate, polypropylene-glutarate, polybutylene-glutarate, polypentylene-glutarate, polyhexalene-glutarate, polyheptadene-glutarate, polyoctalene-glutarate, polyethylene-pimelate, polypropylene-pimelate, polybutylene-pimelate, polypentylene-pimelate, polyhexalene-pimelate, polyheptadene-pimelate, and combinations thereof.

24. The toner particle of claim 1, wherein the first polymer comprises poly(styrene-n-butyl acrylate).

25. The toner particle of claim 1, wherein the amount of the first polymer is from about 40 to about 70 wt % of the total weight of the toner particle.

26. The toner particle of claim 1, wherein the amount of the first polymer is from about 45 to about 65 wt % of the total weight of the toner particle.

27. The toner particle of claim 1, wherein the amount of the first polymer is from about 46 to about 60 wt % of the total weight of the toner particle.

28. The toner particle of claim 1, wherein the glass transition temperature (T_{g}) of the first polymer is from about 45° C. to about 65° C.

29. The toner particle of claim 1, wherein the T_{g} of the first polymer is from about 46° C. to about 64° C.

30. The toner particle of claim 1, wherein the T_{g} of the first polymer is from about 48° C. to about 60° C.

31. The toner particle of claim 1, wherein the weight average molecular weight (M_{w}) of the first polymer is from about 17,000 daltons to about 60,000 daltons.

32. The toner particle of claim 1, wherein the weight average molecular weight (M_{w}) of the first polymer is from about 22,000 daltons to about 38,000 daltons.

33. The toner particle of claim 1, wherein the number average molecular weight (Mₙ) of the first polymer is from about 9,000 daltons to about 18,000 daltons.

34. The toner particle of claim 1, wherein the number average molecular weight (Mₙ) of the first polymer is from about 9,000 daltons to about 13,000 daltons.

35. The toner particle of claim 1, wherein the molecular weight distribution (MWD) of the first polymer is from about 2.1 to about 10.

36. The toner particle of claim 1, wherein the molecular weight distribution (MWD) of the first polymer is from about 2.2 to about 3.3.

37. The toner particle of claim 2, wherein the offset preventing agent is selected from the group consisting of a wax compound.

38. The toner particle of claim 2, wherein the offset preventing agent is selected from the group consisting of Fischer-Tropsch wax, carnauba wax, Japan wax, Bayberry wax, rice wax, sugar cane wax, candelilla wax, tallow, jojoba oil, beeswax, Shellac wax, Spermaceti wax, whale wax, Chinese wax, lanolin, ester wax, capronamide, caprylamide, pelargonic amide, capric amide, laurylamide, tridecanoic amide, myristylamide, stearamide, behenic amide, ethylene-bisstearamide, caproleic amide, myristoleic amide, oleamide, elaidic amide, linoleic amide, erucamide, ricinoleic amide, linolenic amide, montan wax, ozokerite, ceresin, lignite wax, paraffin wax, microcrystalline wax, low-molecular polyethylene, low-molecular polypropylene, low-molecular polybutene, polytetrafluoroethylene wax, Akura wax, and distearyl ketone, castor wax, opal wax, and combinations thereof.

39. The toner particle of claim 2, wherein the offset preventing agent is polyethylene wax.

40. The toner particle of claim 2, wherein the amount of the offset preventing agent is from about 3 to about 30 wt % of the total weight of the toner particle.

41. The toner particle of claim 2, wherein the amount of the offset preventing agent is from about 3 to about 28 wt % of the total weight of the toner particle.

42. The toner particle of claim 2, wherein the amount of the offset preventing agent is from about 3 to about 25 wt % of the total weight of the toner particle.

43. The toner particle of claim 2, wherein the melting temperature (Tₘ) of the offset preventing agent is from about 60° C. to about 120° C.

44. The toner particle of claim 2, wherein the melting temperature (Tₘ) of the offset preventing agent is from about 65° C. to about 110° C.

45. The toner particle of claim 2, wherein the molecular weight (Mₙ) of the offset preventing agent is from about 400 daltons to about 1500 daltons.

46. The toner particle of claim 2, wherein the molecular weight (Mₙ) of the offset preventing agent is from about 500 daltons to about 1000 daltons.

47. The toner particle of claim 3, wherein the silica is in the form of colloidal silica particles with a volume average particle size of from about 5 nm to about 200 nm.

48. The toner particle of claim 3, wherein the silica is colloidal silica particles having a bimodal average particle size distribution.

49. The toner particle of claim 3, wherein the silica comprises a first group of colloidal silica particles having a volume average particle size of from about 5 to about 200 nm, and a second group of colloidal silica particles having a volume average particle size of about 5 to about 200 nm.

50. The toner particle of claim 3, wherein the silica comprises a first group of colloidal silica and a second group of colloidal silica particles, which are in a ratio of from 0.1:10 to 10:0.1 by weight.

51. The toner particle of claim 3, wherein the amount of the silica is from about 0.0 to about 15 wt % of the total weight of the toner particle.

52. The toner particle of claim 3, wherein the amount of the silica is from about 0.0 to about 13 wt % of the total weight of the toner particle.

53. The toner particle of claim 3, wherein the amount of the silica is from about 0.0 to about 10 wt % of the total weight of the toner particle.

54. The toner particle of claim 1, wherein the second polymer comprises at least one of polyester and poly (styrene acrylate).

55. The toner particle of claim 1, wherein the second polymer is in the form of a latex dispersion.

56. The toner particle of claim 1, wherein the second polymer is selected from the group consisting of poly(styrene-n-butyl acrylate), poly(styrene-butadiene), poly( methyl methacrylate-butadiene), poly(ethyl methacrylate-butadiene), poly( propyl methacrylate-butadiene), poly(butyl methacrylate-butadiene), poly(styrene-isoprene), poly(methyl methacrylate-isoprene), poly(ethyl methacrylate-isoprene), poly(propyl methacrylate-isoprene), poly(butyl methacrylate-isoprene), poly(styrene-propyl acrylate), poly(styrene-2-ethylhexyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-2-ethylhexyl acrylate-acrylic acid), poly(styrene-butyl acrylate-methacrylic acid), poly(styrene-2-ethylhexyl acrylate-methacrylic acid), poly(styrene-butyl acrylate-acrylononitrile), poly(styrene-butyl acrylate-acrylononitrile-acrylic acid), poly(methyl methacrylate-propyl acrylate), poly(methyl methacrylate-butyl acrylate), poly(methyl methacrylate-butadiene-acrylic acid), poly(methyl methacrylate-butadiene-methacrylic acid), poly(methyl methacrylate-butadiene-acrylonitrile-acrylic acid), poly(methyl methacrylate-butyl acrylate-acrylic acid), poly(methyl methacrylate-butyl acrylate-methacrylic acid), poly(methyl methacrylate-butyl acrylate-acrylononitrile), poly(styrene-butyl acrylate-acrylononitrile-acrylic acid), polyethylene-terephthalate, polypropylene-terephthalate, polybutylene-terephthalate, polypentylene-terephthalate, polyhexalene-terephthalate, polyheptadene-terephthalate, polyoctalene-terephthalate, poly(propylene-diethylene terephthalate), poly(bisphenol A-fumarate), poly(bisphenol A-terephthalate), copoly(bisphenol A-terephthalate)-copoly(bisphenol A-fumarate), poly(neopentyl-terephthalate), polyethylene-sebacate, polypropylene-sebacate, polybutylene-sebacate, polyethylene-adipate, polypropylene-adipate, polybutylene-adipate, polypentylene-adipate, polyhexalene-adipate polyheptadene-adipate, polyoctalene-adipate, polyethylene-glutarate, polypropylene-glutarate, polybutylene-glutarate, polypentylene-glutarate, polyhexalene-glutarate, polyheptadene-glutarate, polyoctalene-glutarate, polyethylene-pimelate, polypropylene-pimelate, polybutylene-pimelate, polypentylene-pimelate, polyhexalene-pimelate, polyheptadene-pimelate, and combinations thereof.

57. The toner particle of claim 1, wherein the second polymer comprises poly(styrene-n-butyl acrylate).

58. The toner particle of claim 1, wherein the amount of the second polymer is from about 10 to about 50 wt % of the total weight of the toner particle.

59. The toner particle of claim 1, wherein the amount of the second polymer is from about 12 to about 40 wt % of the total weight of the toner particle.

60. The toner particle of claim 1, wherein the amount of the second polymer is from about 15 to about 35 wt % of the total weight of the toner particle.

61. The toner particle of claim 1, wherein the glass transition temperature (T_{g}) of the second polymer is from about 45° C. to about 65° C.

62. The toner particle of claim 1, wherein the T_{g} of the second polymer is from about 46° C. to about 64° C.

63. The toner particle of claim 1, wherein the T_{g} of the second polymer is from about 48° C. to about 60° C.

64. The toner particle of claim 1, wherein the weight average molecular weight (M_{w}) of the second polymer is from about 17,000 to about 60,000 daltons.

65. The toner particle of claim 1, wherein the weight average molecular weight (M_{w}) of the second polymer is from about 22,000 to about 38,000 daltons.

66. The toner particle of claim 1, wherein the number average molecular weight (Mₙ) of the second polymer is from about 9,000 to about 18,000 daltons.

67. The toner particle of claim 1, wherein the number average molecular weight (Mₙ) of the second polymer is from about 9,000 to about 13,000 daltons.

68. The toner particle of claim 1, wherein the molecular weight distribution (MWD) of the second polymer is from about 2.1 to about 10.

69. The toner particle of claim 1, wherein the molecular weight distribution (MWD) of the second polymer is from about 2.2 to about 3.3.

70. The toner particle of claim 1, which has a particle size of about 5.0 microns to about 6.5 microns.

71. The toner particle of claim 1, which has a particle size of about 5.3 microns to about 6.0 microns.

72. The toner particle of claim 1, having a GSD (v) of from about 1.15 to about 1.30.

73. The toner particle of claim 1, having a GSD (v) of from about 1.18 to about 1.27.

74. The toner particle of claim 1, having a GSD (v) of from less than 1.25.

75. The toner particle of claim 1, having a GSD (n) of from about 1.18 to about 1.40.

76. The toner particle of claim 1, having a GSD (n) of from about 1.20 to about 1.30.

77. The toner particle of claim 1, having a GSD (n) less than about 1.30.

78. A method of improving the parent charge properties of a toner particle containing a complexed cationic dye pigment, comprising introducing a heteropoly acid into the toner particle to complex with and retain the free cationic dye within the toner particle.

79. A method of preparing a toner particle, comprising (a) aggregating a first polymer, a complexed cationic dye pigment, a heteropoly acid to construct the core of the toner particle; (b) adding a second polymer to form the shell of the toner particle; and (c) optionally isolating, washing, and drying the toner particles.

80. A method of preparing a toner particle, comprising (i) providing a heteropoly acid aqueous solution, optionally at elevated temperature; (ii) dispersing a complexed cationic dye pigment, a first polymer, and optionally an offset preventing agent into an aqueous phase containing the solution from step (i); (iii) providing an acidic mixture comprising a coagulant and a silica; (iv) initiating the toner core formation by admixing the mixtures from steps (ii) and (iii) at effectively high shearing; (v) heating the resulting sheared blend of (iv) below about the glass transition temperature (T_{g}) of the first polymer; (vi) adding a second polymer to form a shell around the core; (vii) adjusting the pH of the system with a base from pH of 2.0˜2.5 to pH of 6.5˜7.0 to prevent, or minimize additional particle growth; (viii) heating the resulting aggregate suspension to a temperature above the T_{g} of the first and second polymers; (iv) optionally treating the toner particles with acidic solutions; (v) optionally isolating, washing, and drying the toner particle.

81. The method of claim 80, in which the coagulant comprises a poly(metal halide).

82. The method of claim 80, in which the coagulant comprises poly(aluminium chloride).

83. The method of claim 80, in which the coagulant comprises poly(metal sulfosilicate).

84. The method of claim 80, in which the coagulant comprises poly(aluminium sulfosilicate).

85. The method of claim 80, in which the coagulant comprises salts of bivalent and trivalent metals.

86. The method of claim 80, in which the coagulant is selected from the group consisting of iron(II) sulfate, zinc chloride, magnesium chloride, iron(III) sulfate, zinc sulfate, aluminum sulfate, iron(II) chloride, iron(III) chloride, magnesium sulfate, and the mixture thereof.

87. The method of claim 80, in which the coagulant comprises an organic coagulant.
